(19) United States
(12) Patent Application Publication
(10) Pub. No.: US 2016/0103337 A1
(43) Pub. Date: Apr. 14, 2016

(54) EYE PATCH ATTACHABLE TO EYEGLASSES

(71) Applicant: Stephen M. Loner, Clearwater, FL (US)

(72) Inventor: Stephen M. Loner, Clearwater, FL (US)

(21) Appl. No.: 14/831,346

(22) Filed: Aug. 20, 2015

Related U.S. Application Data
(60) Provisional application No. 62/062,544, filed on Oct. 10, 2014.

(51) Int. Cl. G02C 7/16

(52) U.S. Cl. CPC G02C 7/16; G02C 2202/10

(57) ABSTRACT

An eye patch formed of a flexible, opaque material is attached to a pair of eyeglasses. The patch has an asymmetric conical shape when in repose. The patch extends from an eyeglass nose bridge around a ninety degree (90°) bend to an eyeglass temple piece and overlies a lens of the eyeglasses. At least one slit is formed in an outboard end of the patch to slidingly receive the eyeglass temple piece. An elastic strap is secured to a peripheral edge of the patch at the inboard end of the patch. The elastic strap underlies the nose bridge so that the nose bridge captures the elastic strap. The peripheral edge of the patch abuts a user's face in encircling relation to an eye when the patch is secured to the eyeglasses so that light is prevented from reaching the eye.

### BACKGROUND OF THE INVENTION

1. Field of the Invention

This invention relates, generally, to the treatment of an eye condition commonly known as “lazy eye.” More particularly, it relates to a flexible eye patch mounted on eyeglasses.

2. Description of the Prior Art

Placing a light-blocking eye patch over a non-lazy eye is an effective means for forcing the muscles of an uncovered, so-called lazy eye to become more active. Treatment times vary but the eye patch treatment is effective for most individuals.

A well-known eye patch is a flat piece of opaque material a little larger than an eye socket that has an adhesive strip that circumscribes the outer periphery of the patch. The adhesive holds the patch in place, much like a band-aide. However, it has the same unwanted qualities of a band-aide, i.e., it loosens with time and requires repeated pressing throughout the day to prevent it from separating from the user's skin. It also loosens when the user perspires, showers, or otherwise gets wet. Many users find it uncomfortable as well, especially those with long eyelashes that rub against the inside surface of the patch.

To avoid the use of adhesives and to position the patch away from the user's eyelashes, inventors have developed patches that are attached to eyeglasses. Some of the known designs position the patch inside the lens, thereby failing to position the patch away from the eyelashes. Other known designs position the patch outside the lens, but they are difficult to attach to the eyeglasses.

What is needed, then, is an eyeglass-mounted, light-blocking eye patch that is positioned outside the lenses of a pair of eyeglasses and which is easy to attach.

Conventional eye patches are manufactured to fit either a left eye or a right eye. Thus there is a need for an eye patch that can fit either eye. An eye patch that can be mounted to eyeglasses to cover a first eye and which can be reversed to cover a second eye would be beneficial.

However, in view of the art considered as a whole at the time the present invention was made, it was not obvious to those of ordinary skill in the art how the needed improved eye patch could be provided.

### SUMMARY OF THE INVENTION

The long-standing but heretofore unfulfilled need for an improved eye patch is now met by a new, useful, and non-obvious invention.

The inventive eye patch is adapted to be releasably attached to a pair of eyeglasses and is formed of a flexible, opaque material having a predetermined length and height. The predetermined length is substantially equal to a distance from an eyeglass nose bridge to a predetermined location on an eyeglass temple piece.

The patch has a substantially ninety degree (90°) bend formed therein by a user to wrap the patch around a corner of the eyeglasses defined by the plane of the lenses of the spectacles and the plane of the temple piece, said planes being normal to one another when the eyeglasses are worn as is well-known.

The patch has an asymmetric conical shape when in repose and has an exterior surface and an interior surface. At least one slit is formed in an outboard end of the patch and said slit is adapted to slidingly receive an eyeglass temple piece. Two closely spaced apart, parallel slits are preferable to a single slit.

An elastic strap is secured at its opposite ends to the peripheral edge of the patch at the inboard end of the patch. The elastic strap overlies the eyeglass nose bridge so that the nose bridge captures the elastic strap after the eyeglass temple piece is slid through the at least one slit.

A peripheral edge of the patch is adapted to abut a user's face in encircling relation to an eye when the patch is secured to the eyeglasses so that light is substantially prevented from reaching the user's eye. Due to the asymmetrical conical shape of the patch, no adhesive is required.

The asymmetrical conical eye patch can be displaced so that the exterior surface of the patch becomes the interior surface of an asymmetrical conical eye patch. The apex of the asymmetrical eye patch is thus displaced from a first side of the patch to a second side thereof. That displacement allows the patch to be used on either eye of the user without affecting the appearance of the patch.

The patch is preferably manufactured by sewing and has a straight seam that extends from the apex of the asymmetrical cone to a peripheral edge of the patch. This provides an aesthetic eye patch because the seam looks natural and well-placed. When the apex of the patch is displaced so that the exterior surface of the patch becomes the interior surface, the patch can be used on a second, opposite eye. The seam then slants in a mirror image way and the same aesthetic effect is maintained.

The patch can also be used on a second eye without displacing the exterior surface of the patch so that it becomes the interior surface, but then the seam does not mirror the seam of the patch when placed over the first eye and the aesthetic effect of the seam is reduced.

An important object of the invention is to provide a patch that overlies a pair of eyeglasses so that the patch does not interfere with the eyelashes of a wearer.

Another object is to provide a patch that lightly contacts a user's face around an eye in the absence of an adhesive yet which blocks light from entering the covered eye.

Another object is to provide an eye patch with an elastic strap secured to the peripheral edge of the patch at the inboard/nose end of the patch to facilitate attachment of the inboard/nose end of the patch to the nose bridge of a pair of eyeglasses after the attachment of the patch to a temple piece of the eyeglasses.

These and other important objects, advantages, and features of the invention will become clear as this disclosure proceeds.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the nature and objects of the invention, reference should be made to the following detailed disclosure, taken in connection with the accompanying drawings, in which:

FIG. 1 is a perspective view of a novel eye patch for covering a left eye;

FIG. 2A is a top plan view thereof;

FIG. 2B is a bottom plan view thereof;

FIG. 3 is a perspective view depicting the patch of FIGS. 1, 2A and 2B when attached in covering relation to the left lens of a pair of eyeglasses and the left eye of a user;

FIG. 4 is a top plan view thereof after the embodiment of FIGS. 1-3 has been rotated one hundred eighty degrees (180°) from its FIG. 2A position;

FIG. 5 is a perspective view of the novel patch when in its FIG. 4 position and when attached in covering relation to the right lens of a pair of eyeglasses and the right eye of a user;

FIG. 6A depicts the structure of FIG. 2A when the apex is displaced by a user so that said apex extends into the plane of the paper;

FIG. 6B depicts the opposite side of FIG. 6A, so that the exterior surface extends out of the plane of the paper towards the viewer; and

FIG. 7 depicts the patch in the FIG. 6B orientation so that the patch is positioned over the right eye of the user.

### DETAILED DESCRIPTION OF THE PREFERRED EMBODIMENT

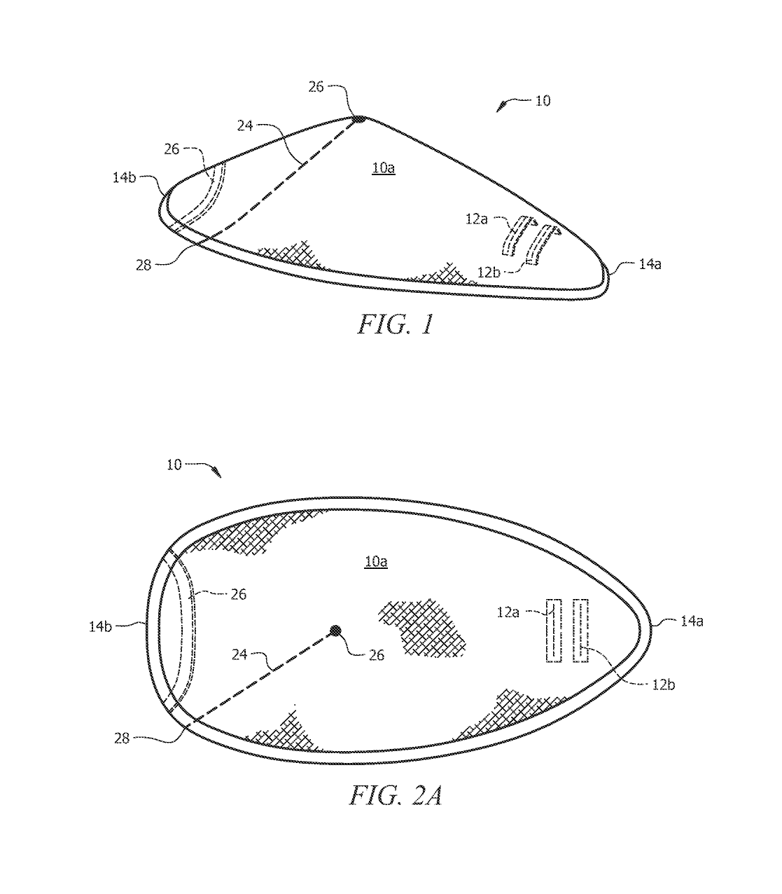

FIG. 1 depicts an illustrative embodiment of the novel structure which is denoted as a whole by the reference numeral 10.

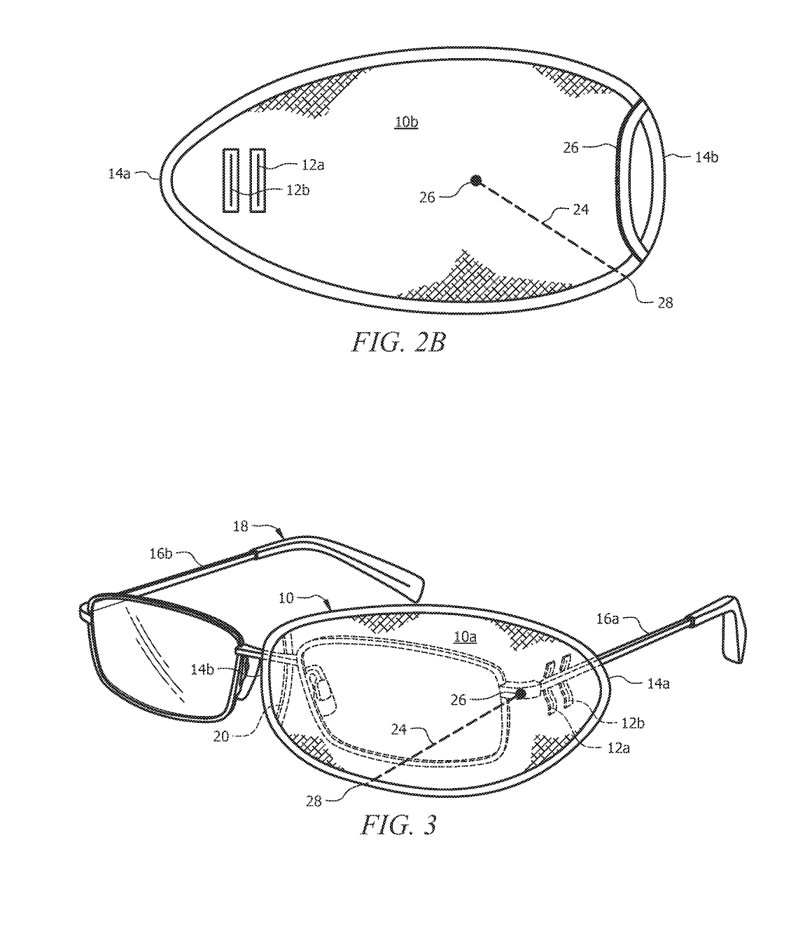

Patch 10 is formed of a flexible, opaque material and has an asymmetric conical shape when in repose as depicted in FIG. 1. The exterior surface of patch 10 is denoted 10a in FIGS. 1, 2A, and 3. Interior surface 10b is depicted in the bottom plan view of FIG. 2B. Said FIG. 2B is produced by flipping FIG. 2A one hundred eighty degrees (180°) about a vertical axis.

Slits 12a and 12b are formed in an outboard end 14a of patch 10 in FIGS. 1-3 and said slits slidingly receive the left eyeglass temple piece 16a of a pair of eyeglasses 18 as worn by a user as best understood in connection with FIG. 3 when a left lens of eyeglasses 18 and a user's left eye are covered.

FIG. 3 depicts in dotted lines elastic strap 20 that is secured at its opposite ends to the peripheral edge of patch 10 at inboard/nose end 14b. In FIG. 3, apex 26 extends out of the plane of the paper, just as in FIGS. 1 and 2A, i.e., toward the viewer and away from the eyes of the user. Apex 26 extends into the plane of the paper in the bottom plan view of FIG. 2B, away from the eyes of the user.

The preferred sewing procedure for making patch 10 creates straight seam 24 which extends from apex 26 of the asymmetrical cone and which extends to a predetermined point 28 on the peripheral edge of the patch. Seam 24 is angled downwardly and to the left in the perspective view of FIG. 1, in the top plan view of FIG. 2A, and in the perspective view of FIG. 3.

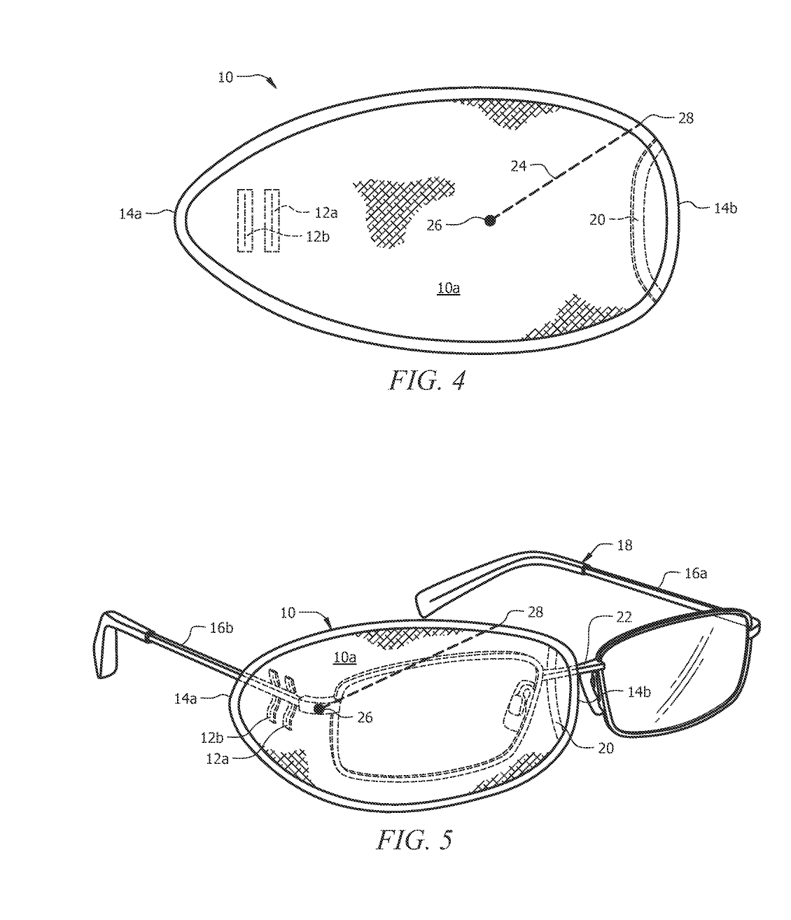

FIG. 4 depicts the structure of FIG. 2A when rotated in the plane of the paper one hundred eighty degrees (180°) so that 14a becomes the outboard end of patch 10 and 14b becomes the inboard end thereof, relative to the user. Apex 26 in FIG. 4 is therefore still extending out of the plane of the paper toward the viewer, which direction is away from the user of the eye patch.

If a patch is manufactured to cover a left eye as depicted in FIGS. 1-3, a user may rotate that patch into its FIG. 4 position, followed by placing right eyeglass temple piece 16b through slits 12a, 12b and placing elastic strap 20 under nose bridge 22 as depicted in the perspective view of FIG. 5.

Patch 10 when in its FIG. 5 configuration performs its light-blocking function over the user's right eye. The only drawback will be that, as depicted in FIG. 5, seam 24 slants upwardly toward the user's nose instead of downwardly as in FIG. 3. That aesthetic effect is visible only to others, not to the wearer of the patch because the inside of the patch is dark to the user and seam 24 is invisible to the user regardless of which way it slants.

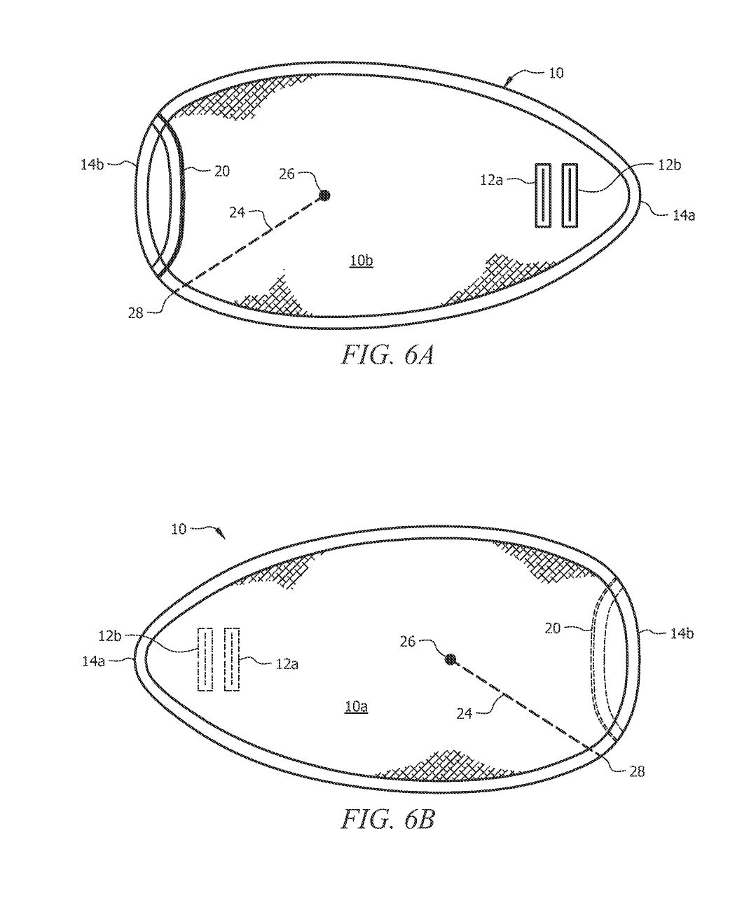

FIG. 6A depicts the structure of FIG. 2A when apex 26 is displaced by a user so that said apex extends into the plane of the paper. Exterior surface 10a thus becomes interior surface 10b.

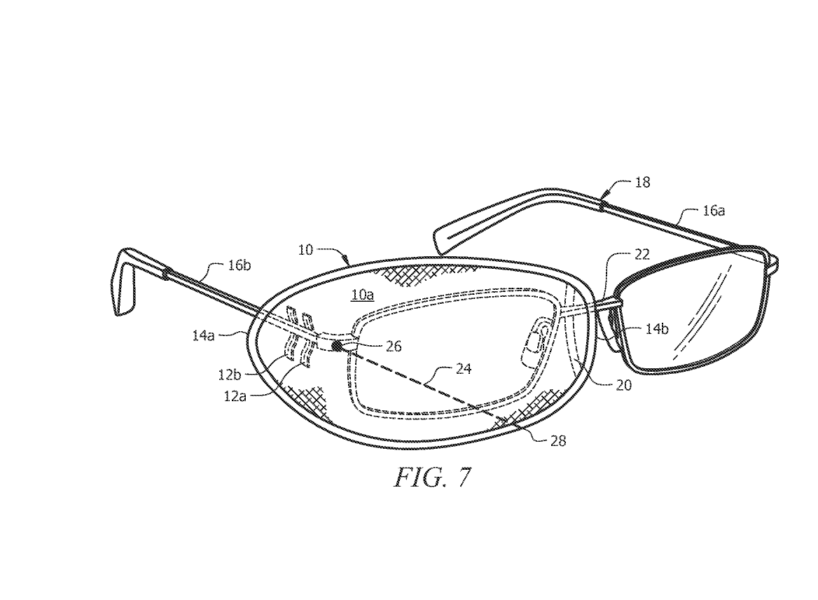

FIG. 6B depicts the opposite side of FIG. 6A, with the structure of FIG. 6A also being rotated one hundred eighty degrees (180°) in the plane of the paper, exterior surface 10a extending out of the plane of the paper toward the viewer in said FIG. 6B. In this FIG. 6B orientation, eyeglass right temple piece 16b is slidingly inserted through slits 12a, 12b and elastic strap 20 is positioned under nose bridge 22 as depicted in FIG. 7. Apex 26 extends away from the covered lens, i.e., away from the user of patch 10 and towards a viewer of the user. Seam 24 slants downwardly and inwardly relative to a viewer and such slant is a mirror image of the slant depicted in FIGS. 2A and 3.

Users who prefer the upward and inward seam slant of FIG. 5 thus leave apex 26 in its FIGS. 1 and 2A orientation when switching a patch from a left eye to a right eye and those wearers who prefer the appearance of FIG. 7 will push the apex of FIGS. 1 and 2A into the plane of the paper to achieve the look of FIG. 7 when switching a patch from a left eye to a right eye.

The flexibility of the eye patch enables a manufacturer to produce one embodiment of the patch. The user can use the patch on either eye and maintain the downward and inward slant of seam 24 by changing apex 26 from one side of the patch to the other, i.e., by switching the convexity of FIG. 1 to a concavity.

It will thus be seen that the objects set forth above, and those made apparent from the foregoing disclosure, are efficiently attained and since certain changes may be made in the above construction without departing from the scope of the invention, it is intended that all matters contained in the foregoing disclosure or shown in the accompanying drawings shall be interpreted as illustrative and not in a limiting sense.

It is also to be understood that the following claims are intended to cover all of the generic and specific features of the invention herein disclosed, and all statements of the scope of the invention that, as a matter of language, might be said to fall therebetween.

What is claimed is:

1. An eye patch adapted to be releasably attached to a pair of eyeglasses, comprising:
said patch formed of a flexible, opaque material having a predetermined length and height;
said predetermined length being substantially equal to a distance from an eyeglass nose bridge to a predetermined location on a temple piece of said eyeglasses;
said patch having a substantially ninety degree (90°) bend formed therein to wrap around a corner of said eyeglasses, said corner defined by a plane that includes the lenses of the eyeglasses and said eyeglass temple piece when said eyeglass temple piece is disposed at a substantially ninety degree angle to said plane;
said patch having an asymmetric conical shape when in repose and having an exterior surface and an interior surface;
at least one slit formed in an outboard end of said patch, said slits adapted to slidingly receive an eyeglass temple piece;
an elastic strap secured at its opposite ends to a peripheral edge of said patch at an inboard end of said patch;
said elastic strap underlying said eyeglass nose bridge so that said nose bridge captures said elastic strap after said eyeglass temple piece is slid through said at least one slit;
said peripheral edge of said patch adapted to abut a user's face in encircling relation to an eye when said eye patch is secured to said eyeglasses so that light is substantially prevented from reaching the user's eye covered by said patch.

2. The eye patch of claim 1, further comprising:
said asymmetrical conical eye patch being displaced so that the exterior surface of said material becomes the interior surface of an asymmetrical conical eye patch.

3. The eye patch of claim 2, further comprising:
said eye patch having a straight seam that extends from a point of said asymmetrical cone to said peripheral edge of said eye patch.
